(19) United States
(12) Patent Application Publication
(10) Pub. No.: US 2023/0143742 A1
(43) Pub. Date: May 11, 2023

(54) METHOD AND APPARATUS FOR DETECTING POLLUTION IN WINDOW COVER OF LIDAR SENSOR

(71) Applicant: HYUNDAI MOBIS CO., LTD., Seoul (KR)

(72) Inventors: Kyung Rin KIM, Yongin-si (KR); Sung Eun JO, Anyang-si (KR)

(73) Assignee: HYUNDAI MOBIS CO., LTD., Seoul (KR)

(21) Appl. No.: 17/861,221

(22) Filed: Jul. 10, 2022

(30) Foreign Application Priority Data
Nov. 5, 2021 (KR) 10-2021-0151611

(51) Int. Cl. G01S 7/497

(52) U.S. Cl. CPC G01S 7/497; G01S 2007/4975

(57) ABSTRACT

An apparatus for detecting pollution in a window cover of a LiDAR sensor includes: a laser signal transmitter that transmits laser signals having a same amplitude and wavelength to one or more pollution detecting regions on the window cover; a reflected signal receiver that receives reflected signals that have been reflected and returned from the one or more pollution detecting regions; a memory that stores one or more instructions; and a processor that executes the one or more instructions stored in the memory to sense pollution on the window cover based on the reflected signals.

### CROSS-REFERENCE TO RELATED APPLICATIONS

This application claims priority to Patent Application No. 10-2021-0151611, filed on Nov. 5, 2021 in Korea, the entire contents of which are incorporated herein by reference.

### TECHNICAL FIELD

The present disclosure relates to a method and apparatus for detecting pollution in a window cover of a Lidar sensor. In detail, the present disclosure relates to a method and apparatus that detects pollution generated in a window cover using a laser signal.

### BACKGROUND

The statements in this section merely provide background information related to the present disclosure and do not necessarily constitute prior art.

The need of a Lidar sensor increases with the development of the autonomous driving technology. A Lidar sensor scans and collects in real time distance information and position information of the surrounding ground configuration and obstacles while a vehicle is moved using a laser beam.

A Lidar sensor includes a laser transmitter, a laser receiver, etc., and has a separate cover protecting the sensor from external contaminants. A Lidar sensor has a window cover, which transmits a laser beam, on the front of a cover because it senses a distance through a method of transmitting and receiving a laser beam.

When pollutants such as soil or dirt stick to the window cover that transmits a laser beam during operation of a Lidar sensor, there is a problem in that the transmission and reception efficiency of a laser beam is deteriorated and accurate sensing of the sensor is difficult due to a shielding effect of the pollutants. Accordingly, it is necessary to prevent and removed pollution of the window cover in order to maintain the performance of the Lidar sensor.

It is required to detect pollution occurring on the window cover in order to prevent pollution of the sensor window cover and remove attached pollutants. Since a laser beam for sensing the surrounding of a Lidar sensor is transmitted and received through the window cover, it is required to develop a pollution detection method that can monitor and sensor generation of pollution on a window cover without influencing transmission and reception of a laser beam for sensing the surrounding. In particular, for a Lidar sensor of a bistatic type configured such that a transmission path and a reception path of a laser beam are separated, there is a need for a new pollution detection method that can check whether a window cover is polluted or not even without using an existing laser beam receiver.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

According to an embodiment, it is possible to monitor whether pollution is generated on a window cover of a Lidar sensor without influencing transmission and reception of a laser beam for sensing the surrounding.

According to an embodiment, it is possible to detect pollution on a window cover even in a Lidar sensor of a bistatic type in which the paths for transmitting and receiving a laser beam of the Lidar are separated.

The objects of the present disclosure are not limited to the objects described above and other objects will be clearly understood by those skilled in the art from the following description.

In one general aspect, an apparatus for detecting pollution in a window cover of a LiDAR sensor includes: a laser signal transmitter configured to transmit laser signals having a same amplitude and wavelength to one or more pollution detecting regions on the window cover; a reflected signal receiver configured to receive reflected signals that have been reflected and returned from the one or more pollution detecting regions; a memory configured to store one or more instructions; and a processor configured to execute the one or more instructions stored in the memory. The processor is configured to execute the one or more instructions to sense pollution on the window cover based on the reflected signals.

The LiDAR sensor may be a bistatic LiDAR sensor.

The laser signal transmitter may be configured to transmit the laser signals simultaneously to the one or more pollution detecting regions using a flash laser type.

The reflected signal receiver may include one or more reflected signal receivers that correspond to the pollution detecting regions on the window cover, and the reflected signals may be received by the reflected signal receivers.

The laser signal transmitter and the reflected signal receiver may be configured to be operated during a time period from when the LiDAR sensor finishes scanning for one frame to when starting scanning for a next frame.

The processor may be configured to: compare a reference amplitude that corresponds to no pollution on the window cover of the LiDAR sensor with an amplitude of a target reflected signal, from among the reflected signals, from a target pollution detecting region included in the pollution detecting regions, and determine that pollution has been generated in the target pollution detecting region when the amplitude of the target reflected signal is larger than the reference amplitude.

In another general aspect, a method for detecting pollution in a window cover of a LiDAR sensor includes: transmitting laser signals having a same amplitude and wavelength to one or more pollution detecting regions on the window cover; receiving reflected signals that have been reflected and returned from the one or more pollution detecting regions; and sensing pollution on the window cover based on the reflected signals.

The transmitting may include transmitting the laser signals simultaneously to the one or more pollution detecting regions using a flash laser type.

The receiving may include receiving the reflected signals using one or more reflected signal receivers that correspond to the pollution detecting regions on the window cover.

The transmitting and the receiving may be performed during a time period from when the LiDAR sensor finishes scanning for one frame to when starting scanning for a next frame.

The sensing may include: comparing a reference amplitude that corresponds to no pollution on the window cover of the LiDAR sensor with an amplitude of a target reflected signal, from among the reflected signals, from a target pollution detecting region included in the pollution detecting regions; and determining that pollution has been generated in the target pollution detecting region when the amplitude of the target reflected signal is larger than the reference amplitude.

According to an embodiment of the present disclosure, whether pollution is generated on a window cover is detected in real time during operation of Lidar sensor without influencing transmission and reception of a laser beam for sensing the surrounding of the Lidar sensor, so there is an effect in that it is possible to prevent deterioration of the performance of the Lidar sensor due to pollution of the window cover.

According to an embodiment of the present disclosure, a Lidar sensor of a bistatic type can detect pollution on a window cover, so there is an effect in that it is possible to improve the performance of the Lidar sensor.

Other features and aspects will be apparent from the following detailed description, the drawings, and the claims.

### BRIEF DESCRIPTION OF THE DRAWINGS

FIG. 1 is a block diagram of a method for detecting pollution in a window cover of a Lidar sensor according to an embodiment of the present disclosure.

FIG. 2 is a view illustrating a process of detecting pollution of a window cover of a Lidar sensor according to an embodiment of the present disclosure.

FIGS. 3A, 3B, and 3C are views illustrating a process of obtaining information about pollution by means of an apparatus for detecting pollution in a window cover of a Lidar sensor according to an embodiment of the present disclosure.

FIG. 4 is a block diagram of a Lidar sensor including the apparatus for detecting pollution in a window cover of a Lidar sensor according to an embodiment of the present disclosure in accordance with another embodiment of the present disclosure.

FIG. 5 is a flowchart illustrating the method for detecting pollution in a window cover of a Lidar sensor according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The description of the present disclosure set forth below in conjunction with the accompanying drawings is intended to describe exemplary embodiments of the present disclosure, and is not intended to represent the only embodiments in which the present disclosure may be practiced.

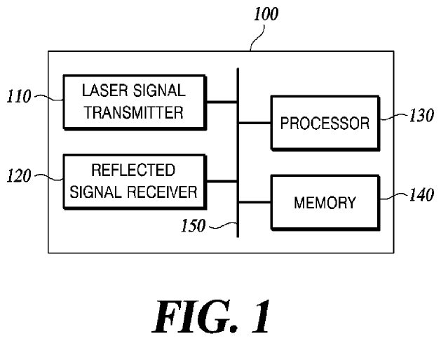

FIG. 1 is a block diagram of a method for detecting pollution in a window cover of a Lidar sensor according to an embodiment of the present disclosure.

Referring to FIG. 1, an apparatus 100 for detecting pollution in a window cover of a Lidar sensor according to an embodiment includes a laser signal transmitter 110, a reflected signal receiver 120, a processor 130, and a memory 140. In the apparatus 100 for detecting pollution in a window cover of a Lidar sensor, the laser signal transmitter 110, the reflected signal receiver 120, the processor 130, and the memory 140 can transmit mutual data through a bus 150. The bus 150 may include a wireless or wired communication-based structure that enables interaction between various components of the apparatus 100 for detecting pollution in a window cover of a Lidar sensor.

The laser signal transmitter 110 transmits laser signals having the same amplitude and wavelength to at least one or more preset pollution detecting regions on a window cover. In this case, the laser signal may be a pulse type laser signal. For example, the laser signal may be a single laser pulse having a pulse width less than 10 ns.

The least one or more preset pollution detecting regions, which are regions where it is required to determine whether there is pollution on the window cover, are regions set in advance as detecting targets of the apparatus 100 for detecting pollution in a window cover. In this case, the pollution detecting region may include a region corresponding to the entire or a portion of the window cover, depending on the sensing range of the Lidar sensor. The pollution detecting region of the apparatus 100 for detecting pollution in a window cover may be set as one or more different regions.

The laser signal transmitter 110 transmits laser signals having the same amplitude and wavelength to one or more pollution detecting regions. A laser signal that is transmitted to a polluted region of the laser signals having the same amplitude and wavelength shows a different type reflected signal from the laser signals that are transmitted to non-polluted regions, so it is possible to easily detect pollution by immediately comparing reflected signals. In this case, the laser signal transmitter 110 can transmit one laser signal simultaneously to a plurality of pollution detecting regions on a window cover using a flash laser type. In this case, the laser signal transmitter 110 transmits and distributes the same laser signals to all of preset pollution detecting regions of the apparatus 100 for detecting pollution in a window cover of a Lidar sensor.

Some of the laser signals transmitted from the laser signal transmitter 110 are reflected by the window cover and returned to the reflected signal receiver 120. The window cover of a Lidar sensor is made of a material that can transmit transmission and reception laser signals of the Lidar sensor. However, even if the signal transmissivity of a window cover is high, it is physically impossible to signals completely pass through the Lidar cover and some of received laser signals at a predetermined ratio are reflected or scattered by the window cover.

The reflected signal receiver 120 receives signals reflected and returned from pollution detecting regions on the window cover.

The reflected signal receiver 120 may include at least one or more reflected signal receivers 120 corresponding to at least one or more preset pollution detecting regions of the apparatus 100 for detecting pollution in a window cover. In this case, the same number of reflected signal receivers 120 as preset pollution detecting regions may be provided, but is not limited thereto, and may be configured as one receiving unit including a plurality of arranged reception elements.

The reflected signal receivers 120 receive reflected signals that are returned from corresponding pollution detecting regions, respectively. For example, when a first pollution detecting region and a second pollution detecting region are set in advance on the window cover, the reflected signal receiver 120 may include a first reflected signal receiver that receives a first reflected signal that is returned from the first pollution detecting region and a second reflected signal receiver that receives a second reflected signal that is returned from the second pollution detecting region.

A Lidar sensor performs scanning on the entire sensing range in accordance with a preset cycle, and one frame of sensing information is created at every cycle. In this case, the one frame of sensing information may include at least one or more items of information of position information and distance information about the entire sensing range of the Lidar sensor.

The apparatus 100 for detecting pollution in a window cover is set such that a scanning operation time period and a window cover pollution detection operation time period of a Lidar sensor are temporally separated from each other.

When some of laser beams transmitted by a Lidar sensor for scanning are received to the reflected signal receiver 120 or some of reflected signal returned from a window cover are received to a reflected light receiver for scanning of the Lidar sensor, the performance of the Lidar sensor and the apparatus 100 for detecting pollution in a window cover may be deteriorated. Accordingly, the apparatus 100 for detecting pollution in a window cover can accurately receives reflected signals by temporarily separately performing transmission and reception processes.

For example, the apparatus 100 for detecting pollution in a window cover may be set such that the laser signal transmitter 110 transmits laser signals to a window cover and the reflected signal receiver 120 receives reflected signals in a time period from when a Lidar sensor finishes scanning for one frame to when scanning of the next frame is started.

When the window cover of a Lidar sensor is polluted, more laser signals are reflected or scattered from the polluted position. The intensity of a reflected signal reflected from a polluted pollution reflected region may be larger than the intensity of a reflected signal when there is no pollution. In this case, the intensity of a reflected signal may be determined on the amplitude value of the reflected signal.

Reflected signals that a plurality of reflected signal receivers 120 receives, respectively, may be signal having different intensities, depending on whether pollution is generated. For example, in the first pollution detecting region and the second pollution detecting region, when pollution is generated in the first pollution detecting region, the signal received by the first reflected signal receiver may have a larger intensity than the signal received by the second reflected signal receiver.

The processor 130, which is a component for detecting pollution on the window cover of a Lidar sensor, may include or may be a portion of a device that can process of a sequence of commands. For example, the processor 130 may include a computer processor, or a processor in an electronic device, or a digital processor.

The processor 130 senses pollution on a window cover on the basis of the reflected signals received by the reflected signal receiver 120.

The processor 130 determines whether pollution is generated on a window cover on the basis of the intensities of reflected signal. In this case, the intensity of a reflected signal may be determined on the basis of the relative magnitude of the amplitude vale of the signal.

When pollution is generated in a pollution detecting region on a window cover, laser signal are difficult to pass through the position where pollution is generated, so the laser signal are reflected or scattered at a higher ratio. Accordingly, the amplitude of a reflected signal reflected from a pollution detecting region where pollution is generated may have a relatively larger value than the amplitude of a reflected signal when pollution is not generated.

The processor 130 determines whether pollution is generated on a window cover on the basis of the intensities of reflected signal. In this case, the intensity of a reflected signal may be determined on the basis of the relative magnitude of the amplitude vale of the signal.

The processor 130 sets the amplitude of a signal when pollution is not generated as a reference amplitude and compares the amplitudes of received reflected signals with the reference amplitude. The processor 130 determined that pollution has been generated when the amplitude of a reflected signal is larger than the reference amplitude. In this case, when the reference amplitude value is the amplitude value of a reflected signal when pollution is not generated, and may have different values, depending on the material and the structure of the window cover of a Lidar sensor. In this case, the reference amplitude value may be stored in advance in the memory 140.

The processor 130 can determine a position where pollution has been generated on a window cover on the basis of information about the reflected signal receiver 120. When the amplitude of a reflected signal is larger than the reference amplitude, the processor 130 determines that pollution has been generated in the pollution detecting region corresponding to the reflected signal receiver 120 receiving a corresponding signal of a plurality of reflected signal receivers 120.

For example, assuming that the left half plane is set as a first pollution detecting region and the right half plane is set as a second pollution detecting region on the window cover of a Lidar sensor, the amplitudes of reflected signals received by the first reflected signal receiver and the second reflected signal receiver, which correspond to the pollution detecting regions, are compared with the amplitude of a reference reflected signal. When the amplitude of a first reflected signal has the same magnitude as or a fine difference from the amplitude of the reference reflected signal but the amplitude of a second reflected signal is remarkably larger than the amplitude of the reference reflected signal, it can be determined that pollution has been generated in the right half plane that is the second pollution detecting region of the window cover.

The memory 140 may include a volatile memory, a permanent memory, a virtual memory, or other memories that are used in the apparatus 100 for detecting pollution in a window cover of a Lidar sensor or that stores information that is output from the apparatus. For example, the memory 140 may include a RAM (random access memory or a DRAM (dynamic RAM).

The memory 140 can store various data for a program for processing or control of the processor 130 and the operation of the apparatus 100 for detecting pollution in a window cover of a Lidar sensor. For example, the memory 140 can store one or more items of information of information about the reference reflected signal for determining whether there is pollution from reflected signals, information about the positions of pollution detecting regions corresponding to a plurality of reflected signal receivers, an information about transmission points of laser signals of the apparatus 100 for detecting pollution in a window cover. The memory 140 can provide information stored therein to the processor 130 in accordance with a request from the processor 130.

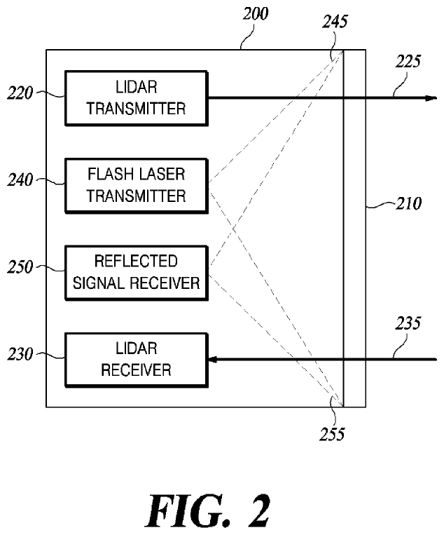

FIG. 2 is a view illustrating a process of detecting pollution of a window cover of a Lidar sensor according to an embodiment of the present disclosure.

Referring to FIG. 1, a Lidar sensor 200 includes a window cover 210, a Lidar transmitter 220, a Lidar receiver 230, a flash laser transmitter 240, and reflected signal receiver 250.

The Lidar sensor 200 obtains frame information of a surrounding environment at every cycle by performing scanning on a sensing range at a predetermined cycle. In this case, the frame information includes the distance and position information of a surrounding environment corresponding to each time cycle.

The Lidar sensor 200 emits laser beams 225 to a plurality of target points in a sensing range through the Lidar transmitter 220. The emitted laser beams 225 reach the target points through the window cover 210 of the Lidar transmitter 220 and then are reflected and returned as reflected beams 235.

The reflected beams 235 are received by the Lidar receiver 230 through the window cover 210. The Lidar sensor 200 can obtain at least one or more items of information of information about the distances and information about the positions of the target points on the basis of TOF (Time of Flight) from when the laser beams 225 are transmitted through the Lidar transmitter 220 to when the reflected beams 234 are received by the Lidar receiver 230.

The Lidar sensor 200 obtains frame information for a first cycle on the basis of at least one or more items of information of the information about the distance and the information about the position of each of the target points.

When the Lidar receiver 230 receives the reflected beams, the flash laser transmitter 240 transmits laser signals 245 to the window cover 210 in a flash type. In this case, the laser signals 245 are simultaneously transmitted to all of pollution detecting regions on the window cover 210.

The reflected signals 255 reflected from the pollution detecting regions are received by the reflected signal receiver 250. When pollution is generated on the window cover 210, the laser signals 245 are reflective or scattered at a higher ratio and the relative intensities of the reflected signals 255 are also increased. It is possible to detect whether pollution has generated on the window cover 210 on the basis of the relative intensities of the reflected signals 255, for example, the magnitudes of the amplitude values of the reflected signals 255 to the reflected signal amplitude values when pollution is not generated.

When the reflected signal receiver 250 finishes receiving the reflected signals 255 for the window cover 210, the Lidar sensor 200 starts scanning for obtaining frame information for a second cycle.

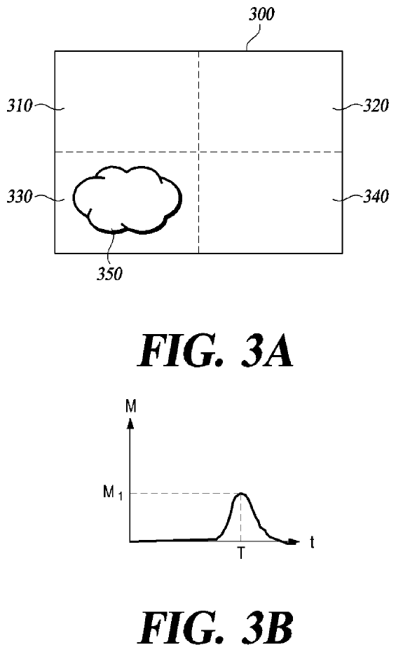

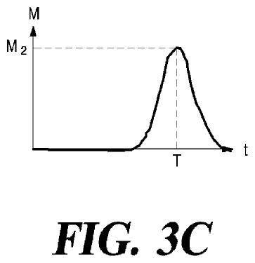

FIG. 3 is a view illustrating a process of obtaining information about pollution by means of an apparatus for detecting pollution in a window cover of a Lidar sensor according to an embodiment of the present disclosure.

FIG. 3A is a view showing the case when pollution is generated in a plurality of pollution detecting regions set on the window cover of a Lidar sensor.

FIG. 3B is a view showing reflected signals when pollution is not generated on a window cover.

FIG. 3C is a view showing reflected signals when pollution is generated on a window cover.

Referring to FIG. 3A, a first pollution detecting region 310, a second pollution detecting region 320, a third pollution detecting region 330, and a fourth pollution detecting region 340. In this case, a plurality of pollution detecting regions is set by dividing the surface of a Lidar sensor in four quadrants, but the method of setting a plurality of pollution detecting regions is not limited thereto.

When laser signals are spread and transmitted to the window cover 300 in a flash type from the laser signal transmitter of the apparatus for detecting pollution in a window cover, some of the transmitted laser signals are returned tot the reflected signal receiver of the apparatus for detecting pollution in a window cover.

The apparatus for detecting pollution in a window cover may include the same number of reflected signal receivers as pollution detecting regions. In this case, the reflected signal receivers may include a first reflected signal receiver, a second reflected signal receiver, a third reflected signal receiver, and a fourth reflected signal receiver that receive reflected signals that are returned from corresponding pollution detecting regions of the first pollution detecting region 310, the second pollution detecting region 320, the third pollution detecting region 330, and the fourth pollution detecting region 340, but is not limited thereto. For example, a reflected signal receiver may be configured as an FPA (Focal Plane Array) that is a multi-array reception signal including a plurality of individual reception elements that can receive reflected signals, respectively.

Referring to FIGS. 3B and 3C, when laser signal are simultaneously transmitted to a plurality of pollution detecting regions on a window cover, reflected signals reflected from the plurality of pollution detecting regions are received to the same point T.

When pollution is not generated on a window cover, reflected signals having an amplitude of are received the reflected signal receiver at the time point T. When pollution is generated on a window cover, reflected signals having an amplitude of are received the reflected signal receiver at the time point T. Since the reflection or scattering ratio of transmitted laser signals is increased by pollution generated on a window cover, the magnitude of the amplitude of the reflected signal is larger than the magnitude of the amplitude of the reflected signal when pollution is not generated.

Referring to FIG. 3A, FIG. 3B, and FIG. 3C again, pollution 350 has been generated in the third pollution detecting region 330, and there is no pollution in the other first pollution detecting region 310, the second pollution detecting region 320, and the fourth pollution detecting region 340.

The reflected signals returned from the first pollution detecting region 310, the second pollution detecting region 320, and the fourth pollution detecting region 340 are shown in the type of FIG. 3B, and the reflected signal returned from the third pollution detecting region is shown in the type of FIG. 3C.

Since the amplitude of the reflected signal received by the reflected signal receiver corresponding to the third pollution detecting region 330 of a plurality of reflected signal receivers shows a larger value than the amplitude of the reflected signals are the other pollution detecting regions, the apparatus for detecting pollution in a window cover of a Lidar sensor can sense that pollution 350 has been generated in the third pollution detecting region 330.

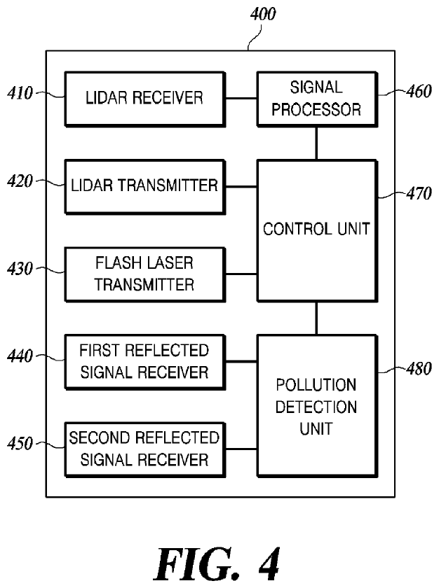

FIG. 4 is a block diagram of a Lidar sensor including the apparatus for detecting pollution in a window cover of a Lidar sensor according to an embodiment of the present disclosure in accordance with another embodiment of the present disclosure.

A Lidar sensor 400 scans a sensing range to obtain at least one or more items of information of the distance information and position information of a surrounding environment. The Lidar sensor 400 includes a Lidar transmitter 420 that emits laser beams to a plurality of target point in a sensing range, and a Lidar receiver 410 for receiving reflected beams that are returned from a plurality of target points.

The Lidar transmitter 420 may include at least one or more of a laser beam source, a collimator including at least one lens, and a mirror and a driving circuit mounted in a motor to be able to control the emission angles of laser beams throughout a sensing range.

The Lidar receiver 410 may include at least one reception element that senses reflected beams of the laser beams transmitted from the Lidar transmitter 420. In this case, the reception element may be an APD (Avalanche Photo Diode). The Lidar receiver 410 may further include a driving circuit for receiving reflected beams other than the reception element.

The Lidar sensor 400 may be a Lidar sensor of bistatic type. In this case, the Lidar transmitter 420 and the Lidar receiver 410 may be spaced a predetermined distance or more apart from each other such that a transmission path of laser beams and a reception path of reflected beams are separated.

The Lidar sensor 400 includes a signal processor 260 that obtains at least one item of information of the distance information and the position information of a surrounding environment on the basis of the signals of reflected beams received by the Lidar receiver 410.

The Lidar sensor 400 includes a flash laser transmitter 430 that transmits and distributes laser signals to a window cover in a flash type, and a reflected signal receiver 440 and 450 that receives reflected signals that are reflected and returned from the a window cover.

The flash laser transmitter 430 may include at least one of a laser beam source, a beam spreader for spreading and transmitting laser signals, and a driving circuit.

A plurality of reflected signal receivers 440 and 450 may be provided. In this case, the number of the reflected signal receivers 440 and 450 may be the same as the number of preset pollution detecting regions on the window cover of a Lidar sensor. For example, a plurality of reflected signal receivers may be a first reflected signal receiver 440 and a second reflected signal receiver 450 that receive reflected signals that are returned from different pollution detecting regions, respectively.

The Lidar sensor 400 includes a pollution detection unit 480 that detects whether pollution is generated on a window cover on the basis of reflected signal received by the first reflected signal receiver 440 and the second reflected signal receiver 450. In this case, the pollution detection unit 480 can obtain information about whether pollution is generated and information about a pollution generation position on the basis of the amplitude value of a reflected signal.

The Lidar sensor 400 includes a control unit 470 for controlling a scanning operation and a pollution detection operation on a window cover of the Lidar sensor 400.

The control unit 470 can control the components of the Lidar sensor 400 so that the flash laser transmitter 430 finishes transmitting laser signals and the reflected signal receivers 440 and 450 finish receiving reflected signals during a time period from when the Lidar sensor 400 finishes one-time scanning one time on a sensing range to when starting the next one-time scanning.

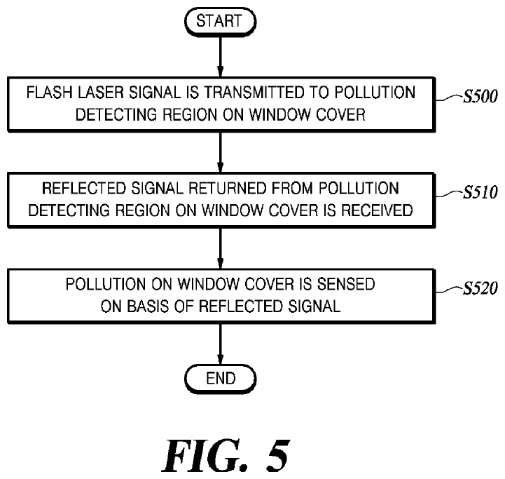

FIG. 5 is a flowchart illustrating the method for detecting pollution in a window cover of a Lidar sensor according to an embodiment of the present disclosure.

Referring to FIG. 5, the apparatus for detecting pollution in a window cover of a Lidar sensor transmits a flash laser signal to a pollution detecting region on a window cover (S500).

The apparatus for detecting pollution in a window cover of a Lidar sensor transmits a laser signal in a flash type to at least one or more preset pollution detecting regions on a window cover. In this case, the laser signal may be a pulse type laser signal.

The t least one or more preset pollution detecting regions, which are preset sensing regions of the apparatus for detecting pollution in a window cover on the window cover of a Lidar sensor, may be regions corresponding to the entire or a portion of the window cover, depending on the sensing region of the Lidar sensor.

The apparatus for detecting pollution in a window cover spreads and transmits one laser signal simultaneously to a plurality of pollution detecting regions on a window cover using a flash laser type. A portion of the transmitted laser signal is reflected or scattered from the window cover at a predetermined ratio and a portion of the transmitted laser signal is reflected and returned from the window cover.

The apparatus for detecting pollution in a window cover of a Lidar sensor receives a reflected signal that is returned from the pollution sensing region on the window cover (S510).

The apparatus for detecting pollution in a window cover may include at least one or more reflected signal receivers corresponding to at least one or more preset pollution defecting regions. In this case, the same number of reflected signal receivers as preset pollution detecting regions may be provided, but is not limited thereto, and may be configured as one receiving unit including a plurality of arranged reception elements. The apparatus for detecting pollution in a window cover receives reflected signals that are returned from pollution detecting regions corresponding to one or more reflected signal receivers, respectively, using the reflected signal receivers.

The apparatus for detecting pollution in a window cover is set such that a scanning operation time period and a window cover pollution detection operation time period of a Lidar sensor are temporally separated from each other. The apparatus for detecting pollution in a window cover may be set to transmit a laser signal to a window cover and receive a reflected signal in a time period from when a Lidar sensor finishes scanning for one frame to when scanning for the next frame is started.

The apparatus for detecting pollution in a window cover of a Lidar sensor senses pollution on the window cover on the basis of the received reflected signals (S520).

When pollution is generated on the surface a window cover of a Lidar sensor, laser signals are difficult to pass through the position where pollution is generated, so the laser signal are reflected or scattered at a higher ratio. Accordingly, the intensity of a reflected signal reflected from a pollution detecting region where pollution is generated may have a relatively larger value than the intensity of a reflected signal when pollution is not generated.

A plurality of reflected signals received by the apparatus for detecting pollution in a window cover of a Lidar sensor may have different intensities, depending on whether there is pollution in corresponding pollution detecting regions.

The apparatus for detecting pollution in a window cover determines whether pollution has been generated on the window cover on the basis of the intensities of the reflected signals. In this case, the intensity of a reflected signal may be determined on the basis of the relative magnitude of the amplitude vale of the signal.

The apparatus for detecting pollution in a window cover compares the amplitudes of the received reflected signals with a reference amplitude on the basis of the amplitudes of reflected signals when pollution is not generated. When the amplitude of a reflected signal is larger than the reference amplitude, it is determined that pollution has been generated.

The apparatus for detecting pollution in a window cover can determine that the position of pollution generated on the window cover of the Lidar sensor on the basis of information about the reflected signal receiver receiving the reflected signal. When the amplitude of a reflected signal is larger than the reference amplitude, the apparatus for detecting pollution in a window cover can determine that pollution has been generated in the pollution detecting region corresponding to the reflected signal receiver receiving a corresponding reflected signal of a plurality of reflected signal receivers.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An apparatus for detecting pollution in a window cover of a LiDAR sensor, the apparatus comprising:
a laser signal transmitter configured to transmit laser signals having a same amplitude and wavelength to one or more pollution detecting regions on the window cover;
a reflected signal receiver configured to receive reflected signals that have been reflected and returned from the one or more pollution detecting regions;
a memory configured to store one or more instructions; and
a processor configured to execute the one or more instructions stored in the memory,
wherein the processor is configured to execute the one or more instructions to sense pollution on the window cover based on the reflected signals.

2. The apparatus of claim 1, wherein the LiDAR sensor is a bistatic LiDAR sensor.

3. The apparatus of claim 1, wherein the laser signal transmitter is configured to transmit the laser signals simultaneously to the one or more pollution detecting regions using a flash laser type.

4. The apparatus of claim 1, wherein the reflected signal receiver includes one or more reflected signal receivers that correspond to the pollution detecting regions on the window cover, and
the reflected signals are received by the reflected signal receivers.

5. The apparatus of claim 1, wherein the laser signal transmitter and the reflected signal receiver are configured to be operated during a time period from when the LiDAR sensor finishes scanning for one frame to when starting scanning for a next frame.

6. The apparatus of claim 1, wherein the processor is configured to:
compare a reference amplitude that corresponds to no pollution on the window cover of the LiDAR sensor with an amplitude of a target reflected signal, from among the reflected signals, from a target pollution detecting region included in the pollution detecting regions, and
determine that pollution has been generated in the target pollution detecting region when the amplitude of the target reflected signal is larger than the reference amplitude.

7. A method for detecting pollution in a window cover of a LiDAR sensor, the method comprising:
transmitting laser signals having a same amplitude and wavelength to one or more pollution detecting regions on the window cover;
receiving reflected signals that have been reflected and returned from the one or more pollution detecting regions; and
sensing pollution on the window cover based on the reflected signals.

8. The method of claim 7, wherein the LiDAR sensor is a bistatic LiDAR sensor.

9. The method of claim 7, wherein the transmitting includes transmitting the laser signals simultaneously to the one or more pollution detecting regions using a flash laser type.

10. The method of claim 7, wherein the receiving includes receiving the reflected signals using one or more reflected signal receivers that correspond to the pollution detecting regions on the window cover.

11. The method of claim 7, wherein the transmitting and the receiving are performed during a time period from when the LiDAR sensor finishes scanning for one frame to when starting scanning for a next frame.

12. The method of claim 7, wherein the sensing includes:
comparing a reference amplitude that corresponds to no pollution on the window cover of the LiDAR sensor with an amplitude of a target reflected signal, from among the reflected signals, from a target pollution detecting region included in the pollution detecting regions; and
determining that pollution has been generated in the target pollution detecting region when the amplitude of the target reflected signal is larger than the reference amplitude.
